(19) United States
(12) Patent Application Publication
(10) Pub. No.: US 2011/0100015 A1
(43) Pub. Date: May 5, 2011

(54) GAS TURBINE SYSTEM TO INHIBIT COKE FORMATION AND METHODS OF USE

(75) Inventors: Rajakumar Alagappan, Bangalore (IN); Paromita Bhattacharya, Bangalore (IN); Santosh Govindrao Suryawanshi, Bangalore (IN); Sudhakar Todeti, Bangalore (IN)

(73) Assignee: GENERAL ELECTRIC COMPANY, Schenectady, NY (US)

(21) Appl. No.: 12/613,011

(22) Filed: Nov. 5, 2009

(51) Int. Cl. F02C 7/22

(52) U.S. Cl. 60/772; 60/734

(57) ABSTRACT

A gas turbine comprising a liquid fuel supply system configured to provide a liquid fuel to a combustion system of the gas turbine; and an additive injection system in fluid communication with the liquid fuel supply system, wherein the additive injection system is configured to mix an additive blend with the liquid fuel to form a liquid fuel-additive mixture configured to inhibit coke formation in the liquid fuel supply system.

### BACKGROUND OF THE INVENTION

This disclosure relates generally to systems for inhibiting coke formation in turbine combustion systems, and more particularly, to methods and systems for the inhibition of coke formation in liquid fuel supply systems of gaseous fuel/liquid fuel combustion turbine systems.

Combustion turbines, such as those used for generating electric power, are often fueled by gaseous hydrocarbon fuel, but have access to an alternative liquid hydrocarbon fuel for use when the gaseous fuel is not available or is undesirable. While the combustion turbine operates with gaseous fuel, an adjacent liquid fuel supply system connected to a fuel distributor in the combustion turbine stores the liquid fuel in standby mode.

The liquid fuel supply system includes an arrangement of pipes and valves and is filled with liquid fuel for use when necessary or desired. Combustion of the gaseous fuel during operation of the combustion turbine produces high temperatures in the combustion chamber of the furnace and in the area adjacent the combustion chamber, including the area occupied by the liquid fuel supply system. The liquid fuel supply system is filled with liquid hydrocarbon fuel, but also includes some oxygen and air leaked through the check valve in the liquid fuel system. The combination of liquid hydrocarbon fuel, oxygen, and high temperatures in the liquid fuel supply system adjacent the combustion chamber of the turbine causes oxidation and partial decomposition of the liquid fuel in the liquid fuel supply system and produces coke therein. This process is referred to as “coking” and the coke forms hard deposits in the liquid fuel supply system that can clog and foul the associated valves and valve screens of the system. Excessive coking and clogging interferes with effective liquid fuel transfer through the liquid fuel supply system and can require the combustion turbine to be shut down for cleaning of the liquid fuel supply system or replacement of its components.

This problem of coking has been addressed by frequently transferring back to liquid fuel from the gaseous fuel supply system to exercise the system components and burn stagnant fuel. This, however, causes operational and financial problems by requiring weekly burning of stagnant liquid fuel, when operation of the combustion turbine with gaseous fuel is normally more economical and desirable.

Another proposed solution is to recirculate liquid hydrocarbon fuel in the liquid fuel supply system, rather than weekly/bi-weekly transfer back to liquid fuel. This option, however, is complex and expensive and therefore undesirable.

Still another proposed solution is to use a water-cooled check valve in the liquid fuel supply system to keep the check valve surfaces below coking temperatures. This option, however, requires hardware changes to the systems as well as a cooling jacket on the check valve. Moreover, this option is limited to one particular piece of hardware in the liquid fuel supply system and is unlikely to be effective in inhibiting the occurrence of coking in areas of the system without water cooling.

Accordingly, there is a need for a simple and economically desirable method for inhibiting coke formation in the liquid fuel supply system of a combustion turbine.

### BRIEF DESCRIPTION OF THE INVENTION

According to one aspect of the invention a gas turbine comprises a liquid fuel supply system configured to provide a liquid fuel to a combustion system of the gas turbine; and an additive injection system in fluid communication with the liquid fuel supply system, wherein the additive injection system is configured to mix an additive blend with the liquid fuel to form a liquid fuel-additive mixture configured to inhibit coke formation in the liquid fuel supply system.

According to another aspect of the invention, a process for inhibiting coke formation in a liquid fuel supply system of a dual-fuel turbine comprises mixing an additive blend with a liquid fuel in an additive injection system to form a liquid fuel-additive mixture, wherein the additive blend is configured to inhibit coking, and wherein the additive injection system is in fluid communication with the liquid fuel supply system; and injecting the liquid fuel-additive mixture into the liquid fuel supply system.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an exemplary embodiment of an additive injection system in communication with a liquid fuel supply system of a gas/liquid combustion turbine system; and

FIG. 2 is a photograph showing four different liquid fuel samples from an experiment to show the effect of the additive blend on coking.

The detailed description explains embodiments of the invention, together with advantages and features, by way of example with reference to the drawings.

### DETAILED DESCRIPTION OF THE INVENTION

Described herein is a system for inhibiting coke formation in turbine combustion systems, and more particularly, to inhibition of coke formation in liquid fuel supply systems of gaseous fuel/liquid fuel combustion turbines. The gaseous fuel/liquid fuel combustion turbine systems (“dual-fuel turbines”) disclosed herein utilize an additive injection system in fluid communication with the liquid fuel supply system of one or more combustion chambers to inhibit coke formation in the liquid fuel supply system to inhibit coke formation therein. The additive injection system can be utilized with the liquid fuel supply systems in one or more of the combustion chambers in a dual-fuel turbine system. The additive injection system is configured to provide an additive that is effective in inhibiting coke formation within the liquid fuel supply system. The additive is a blend whose components can include an antioxidant, a polymer inhibitor, and a metal deactivator. The additive injection system can include a storage tank configured to contain the additive blend, an injection pump configured to supply the additive blend to the liquid fuel supply system, and a control system configured to control the supply of the additive blend to the liquid fuel supply system.

As mentioned above, coke formation can impact turbine systems in a number of ways. Coke formation can reduce the flow area of the liquid fuel lines. Coke formation can harden over time and cause check valves in the system to seize up. Fragments of coke can flake off fuel line surfaces, flow through open check valves, and choke fuel nozzles. Ultimately, the different impact of these coke formations can lead to many of the liquid fuel supply systems in the turbine to become affected; leading to uneven distribution of fuel in the combustors, and ultimately, tripping of the turbine. The additive injection system is configured to inhibit the formation of coke within the liquid fuel supply system by mixing an additive blend with the liquid fuel in the system. The additive blend is configured to substantially inhibit or even prevent the formation of coke caused by the combined presence of stagnant fuel, air, heat, and metal in the liquid fuel supply system. The additive injection system, therefore, can improve the reliability of dual-fuel turbine systems. It also eliminates the need for regularly scheduled fuel changes that are often used to avoid stagnation time in the liquid fuel supply system. Thus, the operating and maintenance costs of a dual-fuel turbine can be significantly reduced by inhibiting coke formation with the additive injection system described herein. Moreover, the additive injection system can be utilized with new or existing dual-fuel turbine systems, and the system can be implemented with only minor modification.

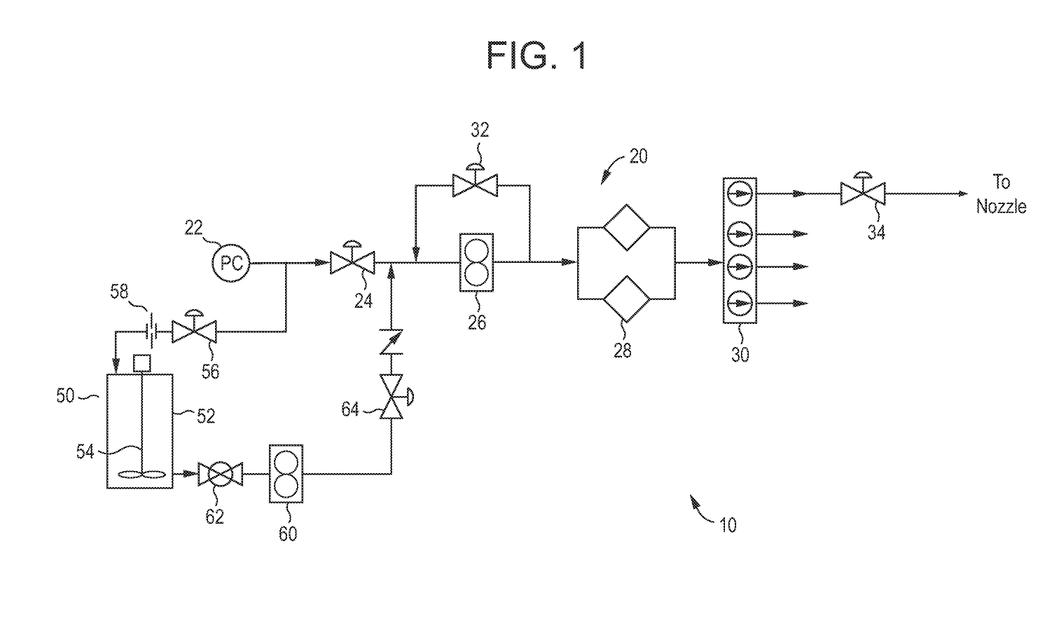

FIG. 1 is a schematic diagram of a dual-fuel turbine 10 including a liquid fuel supply system 20 configured to provide liquid fuel to a combustor, and an additive injection system 50 in fluid communication with the liquid fuel supply system 20. The liquid fuel is supplied to the liquid fuel supply system 20 from a liquid fuel source 22, such as a fuel forwarding system of the turbine 10. During liquid fuel operation, a stop valve 24 between the liquid fuel supply system 20 and the liquid fuel source 22 is opened and fuel forwarding pumps provide liquid fuel flow to the inlet of a liquid fuel pump 26. The liquid fuel pump 26 creates positive fuel flow through fuel filters 28 and into a fuel flow divider 30, which is configured to divide the fuel into a plurality of streams equal to the number of fuel nozzles for each combustor (not shown). A check valve 34 is disposed downstream of the flow divider 30 so that during gas operation, liquid fuel does not back flow through the liquid fuel piping.

During gas operation of conventional dual-fuel turbines, the liquid fuel is normally charged up to the check valve 34 and downstream of check valve 34 is purged with hot air until the air replaces the liquid fuel in the system. The liquid fuel supply system 20 can remain stagnant for long periods of time, in some cases up to ˜6 months. During this stagnant period, the temperature of the liquid fuel supply system can reach or exceed temperatures of 350 degrees Fahrenheit due to its close proximity with the turbine combustion system. Due to the temperature and stagnation time, carbonaceous deposits (i.e., coke) can occur in the check valve and liquid fuel piping of the liquid fuel supply system. Fuel residue can exist on the surfaces of the piping even after the hot air purge, also the hot air can enter the liquid fuel piping/tubing through the liquid fuel check valve. During gas operation, liquid fuel is present upstream of check valve. As the fuel is heated by the temperatures of the surrounding combustion system, the fuel expands and begins leaking from the check valve 34 into the liquid fuel piping downstream of check valve 34 of the system 20. This liquid fuel mixes with the purge air and hot metal surfaces of the system piping and coking begins to occur.

An exemplary embodiment of an additive injection system 50 is shown in FIG. 1 in fluid communication with the liquid fuel supply system 20. The additive injection system is configured to substantially inhibit coking in the liquid fuel supply system 20 that occurs as a result of the conditions described above. The additive injection system 50 includes a storage tank 52 configured to contain an additive blend. The storage tank 52 can have any size and shape configured to hold the desired amount of additive blend, and will depend in part on the size of, and liquid fuel flowrate through, the liquid fuel supply system 20. A mixing device 54 configured to mix the liquid fuel of the liquid fuel supply system 20 with the additive blend can be disposed in the storage tank 52. Exemplary mixing devices will substantially completely mix the additive blend with the liquid fuel and can include, without limitation, stirrers, agitators, paddles, baffles, and the like. A stop valve 56 and a metering orifice 58 are disposed in fluid communication between the main liquid fuel line of the liquid fuel supply system 20 and the storage tank 52. The stop valve 56 is configured to permit or prevent flow of the liquid fuel into the storage tank 52, while the metering orifice 58 is configured to control the amount and/or rate at which the liquid fuel flows into the storage tank 52. Liquid fuel can be diverted from the liquid fuel supply system 20 at any point. In an exemplary embodiment and as shown in FIG. 1, the additive injection system 50 is in initial fluid communication with the liquid fuel supply system 20 upstream of the stop valve 24. Again it is the stop valve 24 which controls flow of the liquid fuel to the fuel pump and, ultimately, to the combustion system. In this location, the liquid fuel can be diverted and mixed (i.e., treated) with the desired amount of additive blend before any untreated fuel is introduced to the liquid fuel supply system 20, particularly to the piping and check valves, which are prone to coking. The additive injection system 50 further includes a recirculation pump 60 disposed at an outlet of the storage tank 52, wherein the pump 60 is configured to pump the liquid fuel-additive mixture back to the liquid fuel supply system 20. In an exemplary embodiment, the recirculation pump 60 is a positive displacement gear pump. A solenoid valve 62 or other similar flow control can be disposed between the storage tank 52 and the recirculation pump 60 to control flow of the mixture to the pump inlet. Finally, a second stop valve 64 is disposed downstream of the recirculation pump 60 and upstream of the liquid fuel supply system 20. In this embodiment, when the stop valve 64 is open, the liquid fuel-additive mixture is pumped to the liquid fuel supply system 20 downstream of the liquid fuel stop valve 24, upstream of the liquid fuel pump 26. The stop valves 56 and 64 serve to isolate the additive injection system 50 from the liquid fuel supply system 20 when desired. Moreover, operation of the stop valves 56, 64 and the metering orifice 58 serve to control the amount and flow rate of liquid fuel into the storage tank 52, thereby controlling the concentration of the additive blend in the liquid fuel. In an exemplary embodiment, a control system is in operative (e.g., electrical) communication with the stop valves and metering orifice. Through control of the stop valves and metering orifice, the control system can control the volume of the liquid fuel flow entering the additive injection system 50, and thereby, the additive concentration of the liquid fuel-additive mixture.

Generally, it is economically more desirable for the dual-fuel turbine 10 to run with the gaseous fuel for as long as possible. However, this leads to the prolonged stagnation periods discussed above. Fortunately, there are times at which it may be necessary to run the turbine 10 with liquid fuel. For example, scarcity of gas fuel in the plant can require the use of liquid fuel until the gaseous fuel is replenished and available for use. The additive injection system 50 is activated when the turbine 10 is running on the liquid fuel. In an exemplary embodiment, the additive injection system 50 is activated just before shut down of the liquid fuel as the turbine 10 is about to transfer back to gaseous fuel operation. At this point, the turbine 10 will typically be running at base load. A portion or all of the liquid fuel flowing through the liquid fuel supply system 20 can be diverted through the additive injection system 20 and mixed with the additive blend. The additive injection system 50 is activated (i.e. stop valves 56 and 64 opened) for a time period effective to substantially completely mix the additive blend with the liquid fuel to the desired concentration, before transition of the turbine 10 back to gas fuel operation. In other words, the additive injection system mixes additive blend into the liquid fuel for a time effective to ensure that the liquid fuel in the piping and check valves after transfer back to gas fuel operation has the desired concentration of additive blend mixed therein. The time period required to effectively mix the additive through the liquid fuel supply system 20 can vary and will depend on a variety of factors including, without limitation, cycle time, liquid fuel volume, liquid fuel line dimensions, and the like. As used herein, “cycle time” is intended to generally refer to the time it takes the entire volume of liquid fuel to travel from stop valve 24 to combustor. This time period is also referred to as “residence time”. The amount of additive blend mixed with the liquid fuel will depend on the cycle time and the liquid fuel line dimensions (i.e., the volume of liquid fuel in the system). In an exemplary embodiment, the additive blend is allowed to mix with the liquid fuel for about 1 to about 8 cycles; specifically about 2 to about 6 cycles; and more specifically about 4 cycles.

In operation, when the turbine system 10 is operating with liquid fuel and it is desired to transfer to gaseous fuel, the additive injection system 50 is activated a predetermined time (e.g., minutes) before transfer of the combustion system from liquid fuel to gaseous fuel. The additive injection system 50 is activated by opening the stop valve 56, which is in a closed position during gas fuel operation. With the stop valve open, the liquid fuel (or a portion thereof) travels into the storage tank 52. Again, the metering orifice 58, is configured to control the rate and volume of liquid fuel flow into the tank. The liquid fuel is mixed in the storage tank with the additive blend to the desired concentration. The amount of additive blend present in the liquid fuel after mixture will again depend on the liquid fuel supply line dimensions and the liquid fuel flow cycle time. In an exemplary embodiment, the additive blend will be mixed with the liquid fuel to a concentration of about 10 to about 200 parts additive blend to 1 million parts liquid fuel (ppm); specifically about 20 ppm to about 80 ppm; and more specifically about 30 ppm to about 40 ppm. The liquid fuel-additive mixture is then fed to an inlet of the recirculation pump 60, wherein the pump drives the mixture through the open stop valve 64 and back into the main fuel line of the liquid fuel supply system 20. After the predetermined time for mixing and recirculation, the liquid fuel-additive mixture is present throughout the liquid supply system 20, thereby effectively inhibiting the formation of coke throughout. In an exemplary embodiment, the liquid fuel-additive mixture is present from the stop valve 24 downstream through the liquid fuel supply system 20 to the combustion system. This includes the liquid fuel supply lines, check valves, filters, dividers, nozzles, and the like. After the desired number of liquid fuel flow cycles, and prior to or simultaneously with transition to gas fuel operation, the additive injection system 50 is deactivated by closing stop valves 56 and 64. The turbine system 10 can then transition from liquid fuel operation back to gaseous fuel operation. For a typical turbine system, the liquid fuel supply lines will then be purged back to the check valve with hot air. Due to the previous operation of the additive injection system, the liquid fuel remaining in the check valves and the residue on the piping will be liquid fuel-additive mixture. As the mixture stagnates under higher pressures and temperatures caused by heat from the combustor, the additive blend in the mixture will substantially inhibit the coking that would typically occur therein.

Exemplary additive blends mixed with the liquid fuel in the additive injection system can be any composition configured to inhibit coking in the liquid fuel supply system of a dual-fuel turbine engine. Further, an exemplary additive blend will be effective at the concentrations specified above for the stagnation times typical of current dual-fuel turbines. Still further, an exemplary additive blend will be effective at the temperatures experienced by a liquid fuel supply system in a dual-fuel gas turbine engine. Exemplary additive blends, therefore, will be effective in inhibiting coking in stagnant liquid fuel at temperatures of about 200 degrees Fahrenheit to about 400 degrees Fahrenheit (about 93 degrees Celsius to about 204 degrees Celsius); and specifically about 300 degrees Fahrenheit to about 350 degrees Fahrenheit (about 149 degrees Celsius to about 177 degrees Celsius). In general, there are four (4) parameters that lead to coking in the liquid fuel supply system; residence time, temperature, the presence of oxygen, and the presence of metal. For existing dual-fuel turbines, it is extremely difficult to avoid any of these parameters. Therefore, an exemplary additive blend is a chemical additive configured to act as a barrier between the liquid fuel and the oxygen and metal. In other words, the additive blend is effective in substantially limiting the effect of these parameters. In an exemplary embodiment, the additive blend comprises three (3) different components, wherein each component has a particular effect on the coke causing parameters in the liquid fuel supply system. The exemplary 3 component additive blend comprises an antioxidant, a polymer inhibitor, and a metal deactivator. In one embodiment, the 3 components are present in the additive blend in equal amounts. In another embodiment, the 3 components are present in the additive blend in different amounts. The particular composition of the components chosen and the amounts in which they are present in the additive blend will depend on the conditions and factors influencing coke formation in the liquid fuel supply system. For different turbine systems, the most effective additive blend may vary. Those having skill in the art will readily be able to determine the most effective combination of antioxidant, polymer inhibitor, and metal deactivator based on a variety of parameters such as, without limitation, liquid fuel supply line dimensions, liquid fuel type, average system temperatures and pressures, and the like. The components can be mixed to produce the additive blend in any manner known to those having skill in the art. In an exemplary embodiment, the 3 component additive blend will be liquid at standard liquid fuel supply system temperatures and will be miscible with the liquid fuel. In some cases, it may be necessary to dissolve one or more of the components in a solvent, such as a non-polar solvent for the purpose of providing a formulation mixable with the liquid fuel.

The antioxidant component of the 3 component additive blend can be any antioxidant composition configured to inhibit the effect of the oxygen on the liquid fuel present in the liquid fuel supply system. The antioxidant component can be a single antioxidant composition or a combination of antioxidants. Exemplary antioxidants that can be used either individually or in combination of two or more include, without limitation, phosphorous-containing antioxidants, phenol-based antioxidants, amine-based antioxidants, and the like. Exemplary phosphorus-containing antioxidants include, without limitation, bis(2,4-di-t-butylphenyl)pentaerythritol diphosphite, phenyldiisodecyl phosphite, diphenyldiisooctyl phosphite, diphenyldiisodecyl phosphite, triphenyl phosphite, trisnonylphenyl phosphite, tris-dinonylphenyl phosphite, tris-(2,4-di-t-butylphenyl) phosphite, distearyl pentaerythritol diphosphite, bis(nonylphenyl) pentaerythritol diphosphite, 4,4′-isopropylidenediphenolalkyl phosphite, 4,4′-butylidene bis(3-methyl-6-t-butylphenylditridecyl phosphite), 1,1,3-tris(2-methyl-4-di-tridecylphosphite-5-t-butylphenyl) butane, tetrakis(2,4-di-t-butylphenyl)-4,4′-bisphenylene diphosphite, 3,4,5,6-dibenzo-1,2-oxaphosphan-2-oxide, trilauryltrithiophosphite, tris(isodecyl) phosphite, tris(tridecyl) phosphite, phenyldi(tridecyl)phosphite, diphenyltridecyl phosphite, phenyl bisphenol A pentaerythritol diphosphite, 3,5-di-t-butyl-4-hydroxybenzyl diethyl phosphate, and the like.

Exemplary phenol-based antioxidants used in the 3 component additive blend includes, without limitation, 2,6-di-t-butyl phenol, 2-t-butyl-4-methoxyphenol, 2,4-dimethyl-6-t-butyl phenol, 2,4-diethyl-6-t-butylphenol, 2,6-di-t-butyl-p-cresol, 2,6-di-t-butyl-4-ethylphenol, 2,6-di-t-butyl-4-hydroxy methylphenol, 2,6-di-t-butyl-4-(N,N-dimethylaminomethyl)phenol, n-octadecyl-β-(4′-hydroxy-3′,5-di-t-butylphenyl) propionate, 2,4-(n-octylthio)-6-(4-hydroxy-3′,5′-di-t-butyl anilino)-1,3,5-triazine, styrenated phenol, styrenated cresol, tochophenol, 2-t-butyl-6-(3′-t-butyl-5′-methyl-2′-hydroxy benzyl)-4-methylphenyl acrylate, 2,2′-methylenebis(4-methyl-6-t-butylphenol), 2,2′-methylenebis(4-ethyl-6-t-butyl phenol), 2,2′-methylenebis(4-methyl-6-cyclohexylphenol), 2,2′-dihydroxy-3,3′-di(α-methylcyclohexyl)-5,5′-dimethyl diphenylmethane, 2,2′-ethylidenebis(2,4-di-t-butylphenol), 2,2′-butylidenebis(4-methyl-6-t-butylphenol), 4,4′-methylenebis(2,6-di-t-butylphenol), 4,4′-butylidenebis(3-methyl-6-t-butylphenol), 1,6-hexanediol bis[3-(3,5-di-t-butyl-4-hydroxyphenyl)propionate], triethylene glycol bis-3-(t-butyl-4-hydroxy-5-methylphenyl)propionate, N,N′-bis-[3-(3,5-di-t-butyl-4-hydroxyphenyl)propionyl]hydrazine, N,N′-hexamethylene bis-(3,5-di-t-butyl-4-hydroxy)hydro cinnamide, 2,2′-thiobis(4-methyl-6-t-butylphenol), 4,4′-thiobis(3-methyl-6-t-butylphenol), 2,2-thiodiethylene bis-[3 (3,5-di-t-butyl-4-hydroxyphenyl)propionate], bis[2-t-butyl-4-methyl-6-(3-t-butyl-5-methyl-2-hydroxybenzyl)phenyl]terephthalate, 1,1,3-tris(2-methyl-4-hydroxy-5-t-butylphenyl)butane, 1,3,5-trimethyl-2,4,6-tris(3,5-di-t-butyl-4-hydroxybenzyl)benzene, tris(3,5-di-t-4-hydroxy benzyl) isocyanurate, 1,3,5-tris(4-t-butyl-3-hydroxy-2,6-dimethylbenzyl) isocyanurate, tetrakis[methylene-3-(3′,5′-di-t-butyl-4-hydroxyphenyl) propionate]methane, calcium(3,5-di-t-butyl-4-hydroxybenzylmonoethylphosphonate), propyl gallate, octyl gallate, lauryl gallate, 2,4,6-tri-t-butylphenol, 2,5-di-t-butylhydroquinone, 2,5-di-t-amylhydro quinone, 1,1,3-tris-(2-methyl-4-hydroxy-5-t-butylphenyl) butane, 1,3,5-trimethyl-2,4,6-tris-(3,5-di-t-butyl-4-hydroxybenzyl)benzene, 3,9-bis[2-{3-(3-t-butyl-4-hydroxy-5-methylphenyl)propionyloxy)-1,1-dimethylethyl)-2,8,10-tetrao xaspiro[5,5]undecane, and the like. In an exemplary embodiment, the phenol-based antioxidant used in the 3 component additive blend is dimethyl-aminomethyl phenol, commercial examples of which are Hitech® 4702 and 4710 available from Albemarle® Corporation.

Exemplary amine-based antioxidants can include, without limitation, p,p′-dioctyldiphenylamine, N-phenyl-N′-isopropyl-p-phenylenediamine, poly-2,2,4-trimethyl-1,2-dihydroquinoline, 6-ethoxy-2,2,4-trimethyl-1,2-dihydroquinoline, thiodiphenylamine, 4-amino-p-diphenylamine, and the like.

The polymer inhibitor component of the 3 component additive blend can be any polymer inhibitor composition configured to inhibit the effect of the high temperature and hot air on the liquid fuel in the system. The polymer inhibitor should inhibit oxygen and temperature based polymerization of hydrocarbons in the fuel. The polymer inhibitor component can be a single polymer inhibitor composition or a combination of inhibitors. Polymer inhibitors are also sometimes referred to as “gum inhibitors”. Exemplary polymer inhibitors that can be used either individually or in combination of two or more include, without limitation phenylenediamine compounds such as N-phenyl-N′(1,3-dimethylbutyl)-p-phenylenediamine, N-phenyl-N′(1,4-dimethylpentyl)-p-phenylenediamine, N-phenyl-N′(1,4-dimethylpropyl)-p-phenylenediamine, and the like; phenolics such as ortho-tert-butyl-para-methoxyphenol, cresylic acid, aminophenol, 2,6-ditertiarybutylphenol, 4,4′methylenebis-(2,6-ditertiarybutylphenol), and the like; quinones such as tertiary butyl catechol, benzoquinone, tetrabutyl hydroquinone, and the like; alkaline earth salts of alkylphenol sulfides, such as calcium or magnesium sulfurized phenates, and the like; sulfur/amine containing materials such as phenothiazine and alkylated derivatives; sulfur/phosphorus containing materials such as metal or amine salts of dialkyl dithiophosphoric acids, and the like. In an exemplary embodiment, the diamine-based polymer inhibitor used in the 3 component additive blend is N,N′-di-sec-butyl-14-phenylene-diamene, a commercial example of which is UOP-5® available from Universal Oil Products®, Inc.

The metal deactivator component of the 3 component additive blend can be any metal deactivator composition configured to prevent the reaction between the metal in the pipe and valve surfaces with the liquid fuel, steam, and oxygen present in the liquid fuel in the system. The metal deactivators are configured to deactivate the metal which would otherwise catalyze polymerization of impurities in the liquid hydrocarbon fuel. The metal deactivator component can be a single metal deactivator composition or a combination of deactivators. Exemplary metal deactivator that can be used either individually or in combination of two or more include, without limitation, sulfur-based metal deactivators such as N,N-diethylthiourea, N,N-dibutylthiourea, tetramethylthiuram monosulfide, tetrabutylthiuram monosulfide, tetraethylthiuram disulfide, tetrabutylthiuram disulfide, and the like; and phosphorous-based metal deactivators such as S,S,S-tributyl phosphorotrithioate; S,S,S-triphenyl phosphorotrithioate. S,S,S-trihydrocarbyl phosphorotrithioate, and the like. In an exemplary embodiment, a phosphorous-based metal deactivator used in the 3 component additive blend is phenyl di-amine, a commercial example of which is MD-115® available from Ciba-Geigy® of BASF® Inc.

The additive injection system and method of its use in the liquid fuel supply system of a dual-fuel gas turbine engine as described herein can advantageously inhibit coking in the fuel system. Inhibition of coking can increase the life span, efficiency, and production of the gas turbine engine. The additive injection system is disposed in fluid communication with the liquid fuel supply system and is configured to provide an additive blend that is effective in inhibiting the formation of coke in the liquid fuel supply system. By mixing the additive blend with the liquid fuel in the system, the additive injection system can substantially inhibit or even prevent the formation of coke caused by the combined presence of stagnant fuel, air, heat, and metal in the liquid fuel supply system. The additive injection system, therefore, can improve the reliability of dual-fuel turbines. It also eliminates the need for regularly scheduled fuel changes that are often used to avoid stagnation time in the liquid fuel supply system. Therefore, the operating and maintenance costs of a turbine system can be significantly reduced through use of the additive injection system. Moreover, the additive injection system described herein can be utilized with new or existing dual-fuel turbine systems, and the system can be implemented with only minor modification.

The following examples, which are meant to be exemplary, not limiting, illustrate the additive injection system and the effect of the additive blend on inhibiting coking in liquid fuel as described herein.

### EXAMPLES

The following test was used to determine the ability of the additive blend described herein to prevent or substantially inhibit coking in a stagnant liquid fuel at low temperature. Four different samples of a high speed diesel fuel were placed in an INCONEL® alloy vessel. Three of the four samples were heated in an electric heating bath up to a temperature of 200 degrees Celsius. A temperature controller in the electric heating bath held the temperature at 200 degrees Celsius once the fuel reached the temperature. A pressure indicator was used in each sample to observe the pressure in the vessel as the liquid fuel was heated. A relief valve was included in the cover of the heating bath for safety in case of any sudden rises in temperature.

Sample 1 was simply the high speed diesel fuel (HSD fuel) before heating and was never placed in the electric heating bath. Sample 1 was intended to show the comparison of fresh fuel versus stagnant fuel exposed to heat, metal, and air over time. Sample 2 was HSD fuel heated in the electric heating bath with exposure to air only. Sample 2 was intended to show the effect of air only on the fuel. Sample 3 was HSD fuel exposed to stainless steel and heated in the electric heating bath. The vessel was purged with nitrogen dioxide to remove the air and show the effects of only stainless steel on the fuel. Finally, Sample 4 was HSD fuel mixed with the additive blend. Sample 4 was exposed to stainless steel and air to show the effect of both on the HSD fuel-additive mixture. Samples 2-4 were kept at 200 degrees Celsius for a duration of eight days.

The additive blend mixed with the HSD fuel in Sample 4 was a three component additive blend, which included 10 parts per million (ppm) antioxidant, 10 ppm polymer inhibitor, and 10 ppm metal deactivator. The antioxidant was dimethyl-aminomethyl phenol commercially available as Hitech® 4702 from Albemarle® Corporation. The polymer inhibitor was N,N′-di-sec-butyl-14-phenyline-diamine commercially available as UOP-5® from Universal Oil Products®, Inc. The metal deactivator a nonyl phenol based polymer and metal deactivator commercially available as MD-115-A from Ciba-Giegy®, part of BASF®, Inc.

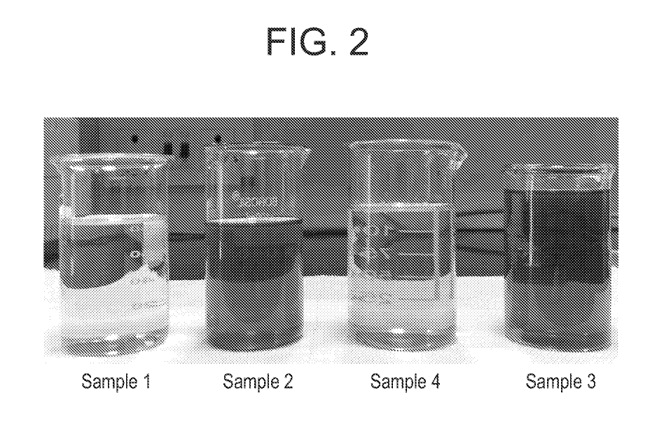

FIG. 2 is a photograph showing each of the four samples. A portion of the HSD fuel from each sample was removed and placed in a clear laboratory beaker in order to observe color change. In FIG. 2, from left to right, are Sample 1, Sample 2, Sample 4, and Sample 3. Sample 1, the far left beaker, is the pure unheated HSD fuel. Sample 1, therefore, provided the visual baseline for comparing the change in color across the other samples. Darker fuel tended to indicate liquid fuel degradation and coke formation. The two samples heated without additive blend, Samples 2 and 3, showed coke formation on the bottom metal surface of the vessels. As can be seen, Sample 2, which was HSD fuel heated and exposed to air, was a darker, brown color compared to the faint yellow color of the clean, unheated HSD fuel of Sample 1. The Sample 2 fuel also wasn't as transparent as that of Sample 1. Similarly, Sample 3 (the far right beaker), which was HSD fuel heated and exposed to stainless steel, was also darker, brown color compared to the faint yellow color of the clean, unheated HSD fuel of Sample 1. Again, the Sample 3 fuel wasn't as transparent as that of Sample 1.

The color and transparency of both Samples 2 and 3 were too similar to draw any particular conclusions as to the rate of liquid fuel degradation and coke formation from exposure to air versus stainless steel. However, it can be seen that the HSD fuel-additive mixture of Sample 4, located second from the right between Samples 2 and 3, was not as dark, brown, or opaque as the non-additive heated samples. Sample 4 was exposed to both air and stainless steel at the same temperature and for the same duration as Samples 2 and 3, yet Sample 4 had a color and transparency much more similar to that of the baseline Sample 1. The lesser change in color and transparency indicated less liquid fuel degradation and coke formation in Sample 4. The sample with the three component additive blend performed visibly better than both of the samples exposed to heat, air, metal, and pressure without the additive. The three-component additive blend was effective in inhibiting liquid fuel degradation and coke formation in the HSD fuel at conditions similar to those that would be experienced by the fuel in a liquid fuel supply system of a dual-fuel gas turbine.

The terminology used herein is for the purpose of describing particular embodiments only and is not intended to be limiting of the invention. Ranges disclosed herein are inclusive and combinable (e.g., ranges of “up to about 25 vol %, or, more specifically, about 5 vol % to about 20 vol %”, is inclusive of the endpoints and all intermediate values of the ranges of “about 5 vol % to about 25 vol %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Unless otherwise defined, all terms (including technical and scientific terms) used herein have the same meaning as commonly understood by one of ordinary skill in the art to which the embodiments of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A gas turbine, comprising:
a liquid fuel supply system configured to provide a liquid fuel to a combustion system of the gas turbine; and
an additive injection system in fluid communication with the liquid fuel supply system, wherein the additive injection system is configured to mix an additive blend with the liquid fuel to form a liquid fuel-additive mixture configured to inhibit coke formation in the liquid fuel supply system.

2. The gas turbine of claim 1, wherein the additive injection system comprises:
a storage tank, configured to hold the additive blend, in fluid communication with a main liquid fuel line of the liquid fuel supply system;
a mixing device disposed in the storage tank configured to mix the liquid fuel with the additive blend and form the liquid fuel-additive mixture; and
a pump in fluid communication with the storage tank and the main liquid fuel line, wherein the pump is configured to pump the liquid fuel-additive mixture into the liquid fuel supply system.

3. The gas turbine of claim 2, wherein the additive injection system further comprises a first stop valve disposed in fluid communication between the main liquid fuel line and the storage tank, wherein the first stop valve is configured to permit or prevent flow of the liquid fuel into the storage tank; and a second stop valve disposed in fluid communication between the main liquid fuel line and the pump, wherein the second stop valve is configured to permit or prevent flow of the liquid fuel-additive mixture into the liquid fuel supply system.

4. The gas turbine of claim 3, wherein the additive injection system further comprises a metering orifice disposed in fluid communication between the first stop valve and the storage tank, wherein the metering orifice is configured to control a liquid fuel flow rate into the storage tank, thereby controlling a concentration of the additive blend in the liquid fuel-additive mixture.

5. The gas turbine of claim 4, wherein the additive injection system further comprises a control system in operative communication with the first and second stop valves and the metering orifice, wherein the control system is configured to control operation of the additive injection system.

6. The gas turbine of claim 1, wherein a concentration of the additive blend in the liquid fuel-additive mixture is about 10 parts additive blend per million parts liquid fuel to about 200 parts additive blend per million parts liquid fuel.

7. The gas turbine of claim 6, wherein a concentration of the additive blend in the liquid fuel-additive mixture is about 20 parts additive blend per million parts liquid fuel to about 80 parts additive blend per million parts liquid fuel.

8. The gas turbine of claim 7, wherein a concentration of the additive blend in the liquid fuel-additive mixture is about 30 parts additive blend per million parts liquid fuel to about 40 parts additive blend per million parts liquid fuel.

9. The gas turbine of claim 1, wherein the additive blend is configured to substantially inhibit coking in the liquid fuel supply system at temperatures of about 200 degrees Fahrenheit to about 400 degrees Fahrenheit.

10. The gas turbine of claim 1, wherein the additive blend comprises an antioxidant, a polymer inhibitor, and a metal deactivator.

11. The gas turbine of claim 10, wherein the antioxidant is a phosphorous-containing antioxidant, a phenol-containing antioxidant, an amine-containing antioxidant, or a combination comprising at least one of the foregoing antioxidants.

12. The gas turbine of claim 10, wherein the polymer inhibitor comprises phenylenediamine compounds, phenolics, quinones, alkaline earth salts of alkylphenol sulfides, sulfur/amine containing materials, sulfur/phosphorus containing materials, or a combination comprising at least one of the foregoing.

13. The gas turbine of claim 10, wherein the metal deactivator comprises sulfur-based metal deactivators, phosphorous-based metal deactivators, or a combination comprising at least one of the foregoing.

14. A process for inhibiting coke formation in a liquid fuel supply system of a dual-fuel turbine, comprising:
mixing an additive blend with a liquid fuel in an additive injection system to form a liquid fuel-additive mixture, wherein the additive blend is configured to inhibit coking, and wherein the additive injection system is in fluid communication with the liquid fuel supply system; and
injecting the liquid fuel-additive mixture into the liquid fuel supply system.

15. The process of claim 14, further comprising activating the additive injection system prior to transfer of the dual-fuel turbine from a liquid fuel operation to a gaseous fuel operation.

16. The process of claim 15, further comprising activating the additive injection system for a time period effective to substantially thoroughly mix the additive blend with the liquid fuel to form the liquid fuel-additive mixture prior to the transfer from liquid fuel operation to gaseous fuel operation.

17. The process of claim 16, wherein the time period is about 1 to about 8 liquid fuel flow cycles.

18. The process of claim 17, wherein the time period is about 2 to about 6 liquid fuel flow cycles.

19. The process of claim 15, further comprising deactivating the additive injection system after forming the liquid fuel-additive mixture and prior to or simultaneously with transfer from liquid fuel operation to gaseous fuel operation.

20. The process of claim 19, wherein activating the additive injection system comprises opening a stop valve disposed in fluid communication between the liquid fuel supply system and the additive injection system, and deactivating the additive injection system comprises closing the stop valve.
